(19) United States
(12) Patent Application Publication
(10) Pub. No.: US 2014/0139886 A1
(43) Pub. Date: May 22, 2014

(54) IMAGE FORMING APPARATUS, IMAGE FORMING METHOD AND PROGRAM

(71) Applicant: CANON KABUSHIKI KAISHA, Tokyo (JP)

(72) Inventor: Tadanori Nakatsuka, Kawasaki-shi (JP)

(73) Assignee: CANON KABUSHIKI KAISHA, Tokyo (JP)

(21) Appl. No.: 14/055,129

(22) Filed: Oct. 16, 2013

(30) Foreign Application Priority Data
Nov. 20, 2012 (JP) 2012-254379

(51) Int. Cl. H04N 1/407

(52) U.S. Cl. CPC H04N 1/4072
USPC 358/3.24

(57) ABSTRACT

At the time of printing by reuse of a backing sheet, a print can not be performed on a blank area thereof. According to an image forming apparatus in the present invention it is determined whether or not a print content is enabled to be printed on a blank area of a document read by a reading unit, and in a case where it is determined that the print content is enabled to be printed, the print content is on the blank area of the document read by the reading unit.

### BACKGROUND OF THE INVENTION

1. Field of the Invention

The present invention relates to an image forming apparatus, an image forming method and a program.

2. Description of the Related Art

In a conventional image forming apparatus, a document conveying system for conveying a document to an image reading unit and a print sheet conveying system for conveying a print sheet to a printing unit are configured independently from each other. That is, each of the document conveying system and the print sheet conveying system is provided independently from each other, each including a feeding component of a document or a print sheet, a guide member forming a conveying path, a plurality of conveying rollers, a drive force transmitting unit to the rollers, a motor as a drive source, a drive circuit of the motor, a discharge component, and the like.

Therefore complexity of an entire mechanism configuration, an increase in cost, and an increase in apparatus size of the image forming apparatus are unavoidable. There is, for solving the problems, proposed a technique that an image reading unit is arranged in the print sheet conveying path from the feeding component to the discharge component to use the document conveying system and the print sheet conveying system in common, thus realizing simplification of the configuration and space saving (refer to Japanese Patent Laid-Open No. 2000-185881).

### SUMMARY OF THE INVENTION

Japanese Patent Laid-Open No. 2000-185881 does not, however, take into account that a printed sheet is read, a blank area of the printed sheet is detected, and a print is performed on the blank area.

An image forming apparatus according to the present invention relates to an image forming apparatus including a reading unit and a printing unit, comprising a conveying unit configured to include a conveying path enabling a print to be performed directly on a document read by the reading unit, and a determining unit configured to determine whether or not the print is enabled on the document based upon an image of the document, wherein in a case where it is determined that the print is enabled by the determining unit, the conveying unit conveys the document to the printing unit such that a print content is printed on the document.

According to the image forming apparatus in the present invention, however a backing sheet is placed as the document to be read, it is possible to perform a print on a white sheet side of the backing sheet and a blank area of the opposite side to the white sheet side of the backing sheet.

Further features of the present invention will become apparent from the following description of exemplary embodiments with reference to the attached drawings.

### BRIEF DESCRIPTION OF THE DRAWINGS

FIG. 1 is a diagram for explaining a one-side printing process of an image forming apparatus according to Embodiment 1;

FIG. 2 is a diagram for explaining a both-side printing process of the image forming apparatus according to Embodiment 1;

FIG. 3 is a diagram for explaining a reading start time of a first side as a front side of a document according to Embodiment 1;

FIG. 4 is a diagram for explaining a reading finish time of the first side as the front side of the document according to Embodiment 1;

FIG. 5 is a diagram for explaining a reading start time of a second side as a back side of the document according to Embodiment 1;

FIG. 6 is a diagram for explaining a reading finish time of the second side as the back side of the document according to Embodiment 1;

FIG. 7 is a diagram for explaining image formation on a print sheet S based upon image information of the first side of the document according to Embodiment 1;

FIG. 8 is a diagram for explaining an operation of a control CPU according to Embodiment 1;

FIG. 9 is a diagram for explaining the configuration of an image reading component according to Embodiment 1;

FIG. 10 is a flowchart for explaining the operation of the control CPU according to Embodiment 1;

FIG. 11 is a flow chart for explaining an operation of a control CPU according to Embodiment 2;

FIG. 12 is a diagram for explaining the operation of the control CPU according to Embodiment 2;

FIG. 13 is a diagram for explaining the operation of the control CPU according to Embodiment 2;

FIG. 14 is a diagram for explaining an operation for forming an image on the read document according to Embodiment 1;

FIG. 15 is a flow chart for explaining an operation of a control CPU according to Embodiment 3 and

FIG. 16 is a diagram showing an example of an operating component in an image forming apparatus.

### DESCRIPTION OF THE EMBODIMENTS

### Embodiment 1

<One-Side Printing Process>

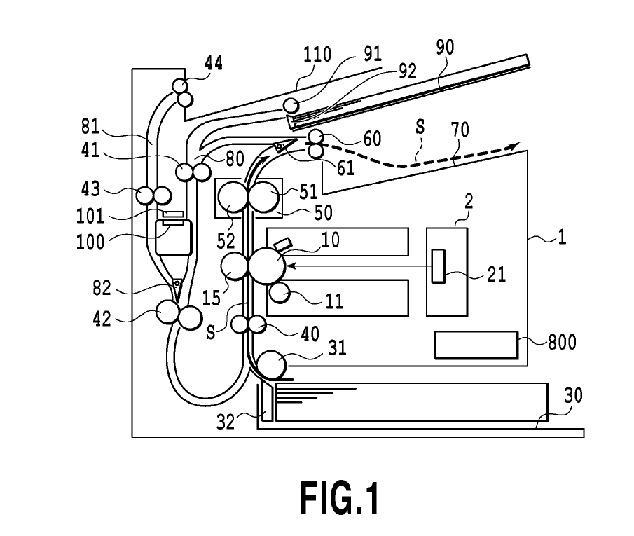

FIG. 1 is a diagram for explaining a one-side printing process in an image forming apparatus according to the present embodiment. A photoconductive drum 10 and a developing roller are located in the image forming apparatus 1. The photoconductive drum 10 is a rotatable image carrier. The developing roller 11 makes parallel contact with the photoconductive drum 10, and rotates while holding toner. In a case where an optical unit 2 receives a print signal, a light emitting component 21 emits laser rays on a surface of the rotating photoconductive drum 10. A latent image is formed on the surface of the photoconductive drum 10, on which the laser rays are emitted, by electrical charge. As the developing roller 11 rotates and supplies the toner to the latent image formed on the surface of the photoconductive drum 10, a toner image is formed on the surface of the photoconductive drum 10.

A first feeding component 30 accommodates print materials such as print sheets therein. An explanation will herein be made of a case where the print material is the print sheet, but the print material may be an overhead projector (OHP) sheet or the like. Print sheets S accommodated in the first feeding component 30 are conveyed to conveying rollers 40 one by one with a cassette tray (CST) pickup roller 31 and a separation unit 32. In FIG. 1, an arrow in a bold line shows the print sheet S at the time the print sheet S is conveyed from the first feeding component 30 to a fixing component 50, and a conveying direction of the print sheet S. The conveying roller 40 adjusts movement timing between a toner image on the surface of the photoconductive drum 10 and a front end of the print sheet S to be in agreement with each other, and conveys the print sheet S to a transfer component 15. The toner image is directed toward the transfer component 15 with rotation of the photoconductive drum 10 and is transferred on the print sheet S by an applying bias and a pressure applied to the transfer component 15. The transfer component 15 conveys the print sheet S to the fixing component 50. In the fixing component 50, heat from a rotatable heating roller 51 and a pressure by a pressure roller 52 fix the toner image on the print sheet S.

The print sheet S on which the toner image is fixed is conveyed to discharge rollers 60. In a case of the one-side print, the discharge roller 60 conveys the print sheet S outside of the apparatus, and the print sheet S is loaded on a first discharge component 70. It should be noted that in FIG. 1, an arrow in a broken line shows the print sheet S at the time a rear end thereof passes a both-side flapper 61, and the conveying direction of the print sheet S.

<Both-Side Printing Process>

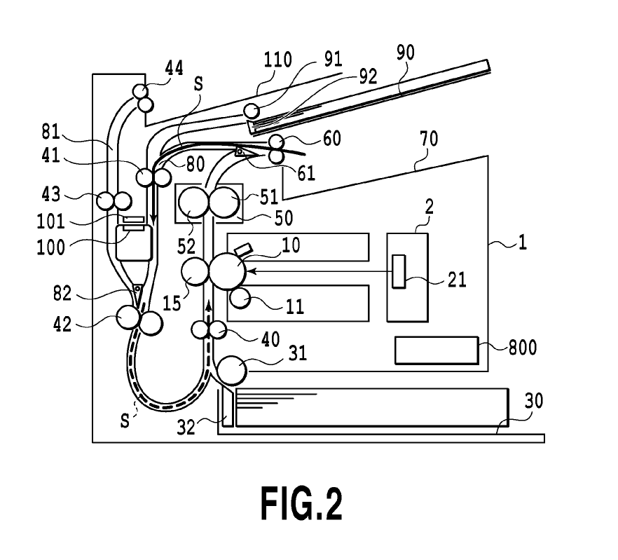

FIG. 2 is a diagram for explaining a both-side printing process in the image forming apparatus according to the present embodiment. After the rear end of the print sheet S a one-side print of which is already performed passes the both-side flapper 61, the both-side flapper 61 switches a conveying path. After that, the discharge roller 60 starts to rotate reversely, and conveys the print sheet S to a both-side conveying path 80. The print sheet S is conveyed to an image reading component 100 by conveying rollers 41. In FIG. 2, an arrow in a bold line shows the print sheet S at this time and the conveying direction of the print sheet S. It should be noted that the image reading component 100 is used for reading an image of a document in a document reading process or a copying process to be described later, and does not operate in the both-side printing process.

After that, the print sheet S is again conveyed to the transfer component 15 by conveying rollers 42 and the conveying rollers 40. In FIG. 2, an arrow in a broken line shows the print sheet S at this time and the conveying direction of the print sheet S. Transfer and fixation of the toner image to the print sheet S are performed, and further, the print sheet S on which the both-side print is performed is loaded on the first discharge component 70.

<Document Reading Process>

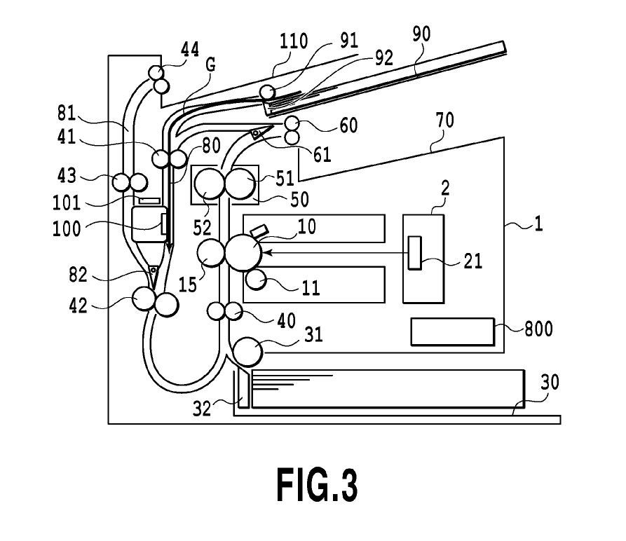

FIG. 3 is a diagram for explaining the reading of a first side of a document in the image forming apparatus according to the present embodiment. Documents G accommodated in a second feeding component 90 are conveyed to the conveying roller 41 one by one by a contact image sensor (hereinafter, CIS) pickup roller 91 and a separation unit 92. In FIG. 3, an arrow in a bold line shows the print sheet G at this time and the conveying direction of the print sheet G.

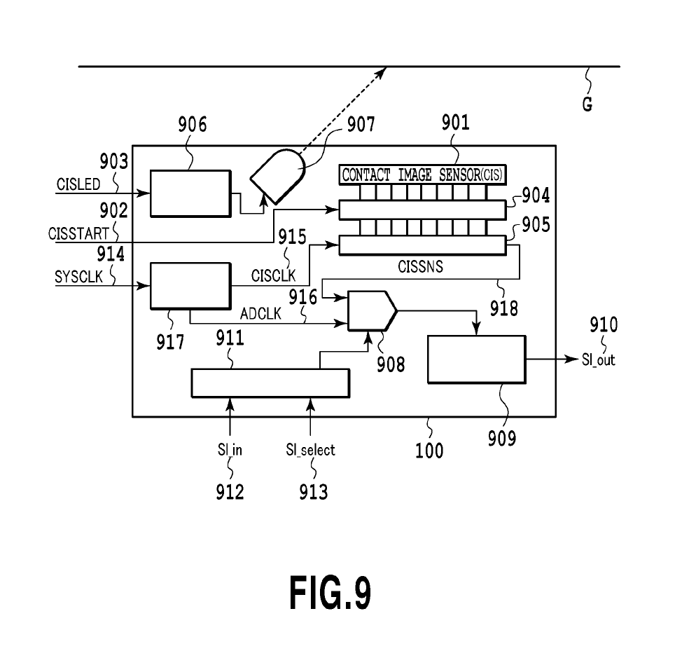

The image reading component 100 performs calculation of a shading corrective coefficient for correcting variations in output level of an image signal due to sensitivity non-uniformity or non-uniformity in optical source/optical quantity of the image reading component 100 and the like before starting with the reading of the first side of the document G. FIG. 3 shows a state where the image reading component 100 is placed in a position of facing the conveying path 80, but for performing the calculation of the shading corrective coefficient, the image reading component 100 is required to be placed in a position of facing a white reference member 101 as shown in FIG. 1 or FIG. 2. In the position where the image reading component 100 faces the white reference member 101, a light emitting element 907 in the image reading component 100 (the details will be explained in FIG. 9) emits light to the white reference member 101, and thereby the image reading component 100 reads a white reference image. In a state where the light emitting element 907 does not emit light, the image reading component 100 reads a black reference image. The shading corrective coefficient is calculated from the read white reference image and black reference image. The calculated shading corrective coefficient is set as a new shading corrective coefficient. After that, the image reading component 100 rotates to a position of facing the both-side conveying path 80. Herein the position of facing the conveying path 80 and the position of facing the white reference member 101 are on a rotation orbit of the image reading component 100.

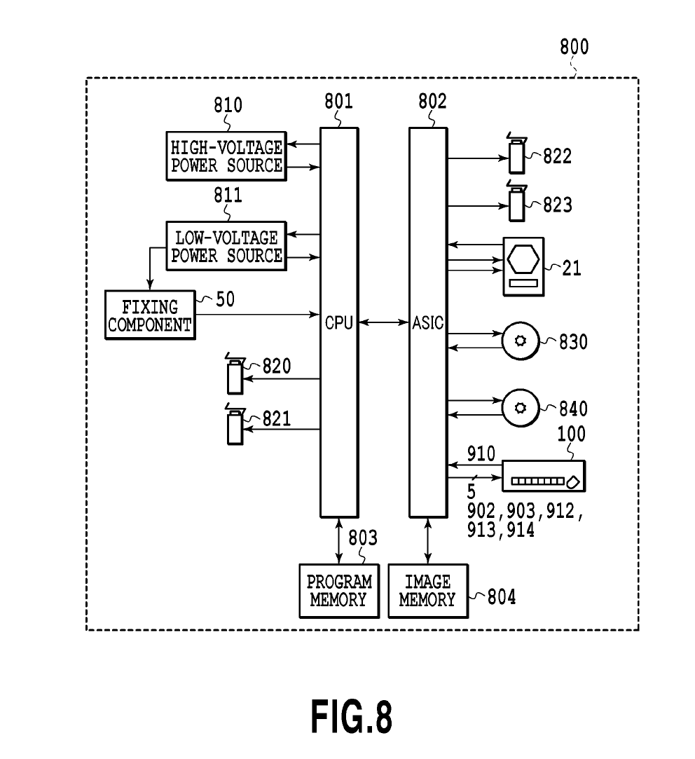

The conveying roller 41 conveys the document G to the image reading component 100. The image reading component 100 which has waited in a position of facing the both-side conveying path 80 reads the first side of the document. The read information is stored in an image memory 804, which will in detail be explained in FIG. 8, as image information of the first side of the document. It should be noted that the downward arrangement of the white reference member 101 is made with consideration for dust attachment thereto. The white reference member 101 is used as the reference member, but the reference member may be a member in color other than white color.

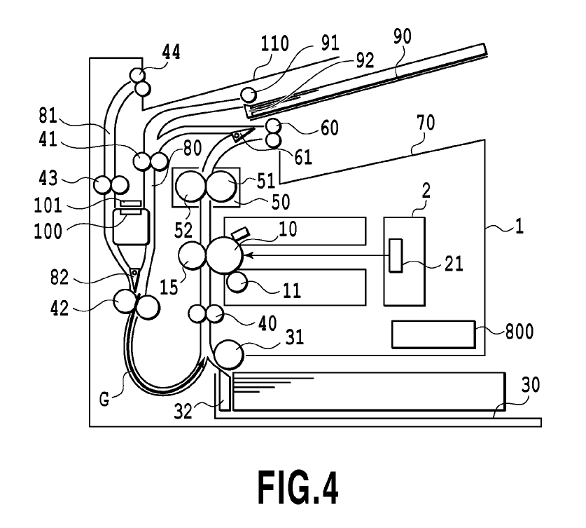

FIG. 4 is a diagram for explaining a reading finish time of the first side of the document. The document G which has passed the image reading component 100 is conveyed to the conveying roller 42. The conveying roller 42 stops at a point where the rear end of the document G passes a switch back flapper 82. At this time, the document G stops in a state of being interposed and held between the conveying rollers 42. After an elapse of a predetermined time, the conveying roller 42 conveys the document G to a document conveying path 81. During this predetermined time, the switch back flapper 82 switches the conveying path from the both-side conveying path 80 to the document conveying path 81.

In addition, after the reading of the first side of the document is finished, the image reading component 100 rotates to a position of facing the white reference member 101. In the position where the image reading component 100 faces the white reference member 101, a shading corrective coefficient is calculated from a white reference image obtained by emitting light to the white reference member 101 by the light emitting element 907 and a black reference image which is obtained by the image reading component 100 in a state where the light emitting element 907 does not emit light. The calculated shading corrective coefficient is set as a new shading corrective coefficient.

It should be noted that it is preferable that the white reference member 101 is installed in the halfway of the rotating of the image reading component 100 for reading the second side of the document after the image reading component 100 finishes the reading of the first side of the document. An explanation is herein made of calculating the shading corrective coefficient each time before reading the first side and the second side of the document, but the calculation of the shading corrective coefficient may be performed periodically or at timing determined as needed.

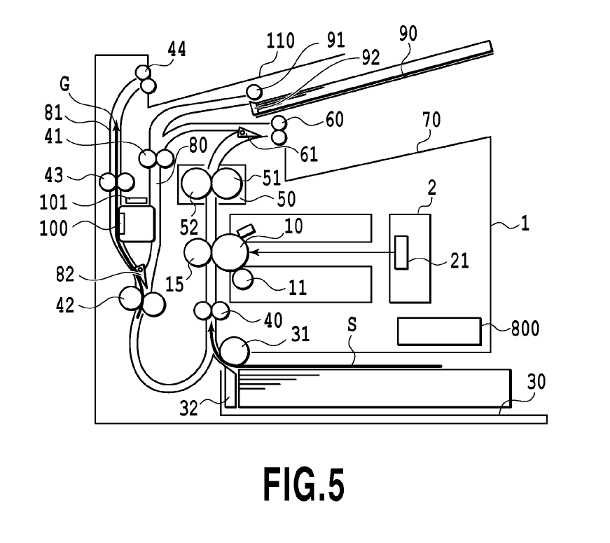

FIG. 5 is a diagram for explaining the reading of the second side of the document. At the same time the switch back flapper 82 switches the conveying path of the document G from the both-side conveying path 80 to the document conveying path 81, the image reading component 100 rotates to a position of facing the document conveying path 81. The conveying roller 42 starts to rotate reversely and conveys the document G to the image reading component 100 through the document conveying path 81. In a case where the document G passes the image reading component 100, the image reading component 100 reads the second side of the document G, and the read image information is stored in the image memory 804 as the image information of the second side of the document G.

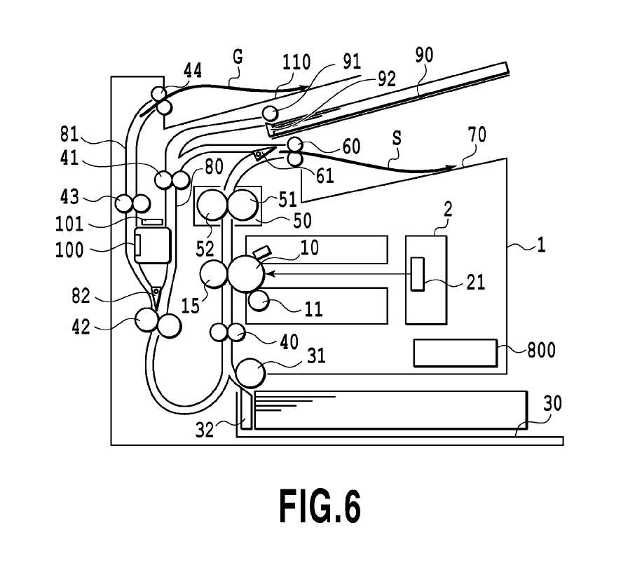

FIG. 6 is a diagram for explaining the reading finish time of the second side of the document. The document G is conveyed outside of the apparatus by conveying rollers 43 and conveying rollers 44, and is loaded on a second discharge component 110.

Herein an explanation is made of a case of reading both the sides of the document, but in some cases only the one side of the document is read depending upon the setting of a user. In a case of the one-side reading, the conveying path of the document G is the same as in a case of the both-side reading, and it becomes unnecessary to read the second side of the document and calculate the shading corrective coefficient prior to the reading.

<Copying Process>

Next, an explanation will be made of a case of a copying operation where a document is read and an image of the read document is printed on a print sheet. In the image forming apparatus according to Japanese Patent Laid-Open No. 2000-185881, for commonly using the document conveying path and the print sheet conveying path, the reading of the document and the printing on the print sheet are performed in order, that is, it is required to start the conveying of the print sheet after reading the document. In the image forming apparatus according to the present embodiment, the reading of the document and the printing on the print sheet can be performed in order without mentioning, but the reading of the document and the printing on the print sheet are not necessarily performed in order. For example, in a case where a user sets the apparatus to make a copy in the form of from one side to one side or from both sides to one side of a document, since there is no overlapping portion between a document conveying path and a print sheet conveying path to be used, the conveying of the print sheet S may start together with the start of the reading of the first side of the document.

The details of the copying operation in the image forming apparatus according to the present embodiment will be explained by taking a case where a user sets the apparatus to make a copy in the form of from both sides to both sides of a document as an example. It should be noted that since the reading operation of the first side and the second side of the document in the copying process is the same as the reading operation of the first side and the second side of the document in the document reading process explained with reference to FIG. 3 to FIG. 6, the explanation is omitted. Hereinafter, an explanation will be made of image formation based upon the image information of the read document G.

In a case where the document G passes the image reading component 100, the image reading component 100 reads the second side of the document G and the read image information is stored in the image memory 804 as the image information of the second side of the document G. On the other hand, print sheets S accommodated in the first feeding component 30 are conveyed to the conveying roller 40 one by one by the CST pickup roller 31 and the separation unit 32. Substantially at the same time, the light emitting component 21 emits laser rays on the surface of the photoconductive drum 10 based upon the image information of the second side in the document G stored in the image memory 804, and a latent image is formed on the surface of the photoconductive drum 10 based upon the image information of the second side in the document G, The transfer component 15 transfers a toner image formed by the latent image on the print sheet S, and the fixing component 50 fixes the toner image to the print sheet S to complete image formation based upon the image information of the second side in the document G. In FIG. 5, the conveying of the print sheet S starts together with the start of the reading of the second side in the document G, but the conveying of the print sheet S may start after the reading of the second side in the document G.

As the reading of the second side in the document G is finished, the document G is conveyed outside of the apparatus by the conveying roller 43 and the conveying roller 44, and is loaded on a second discharge component 110. As the rear end of the document G passes the switch back flapper 82, the switch back flapper 82 switches the conveying path from the document conveying path 81 to the both-side conveying path 80 such that the print sheet S on which the image formation of the second side in the document is completed is conveyed to the conveying roller 40 through the conveying roller 42. The print sheet S on which the image formation of the second side in the document is completed is conveyed to the both-side conveying path 80 switched by the both-side flapper 61 with reverse rotation of the discharge roller 60.

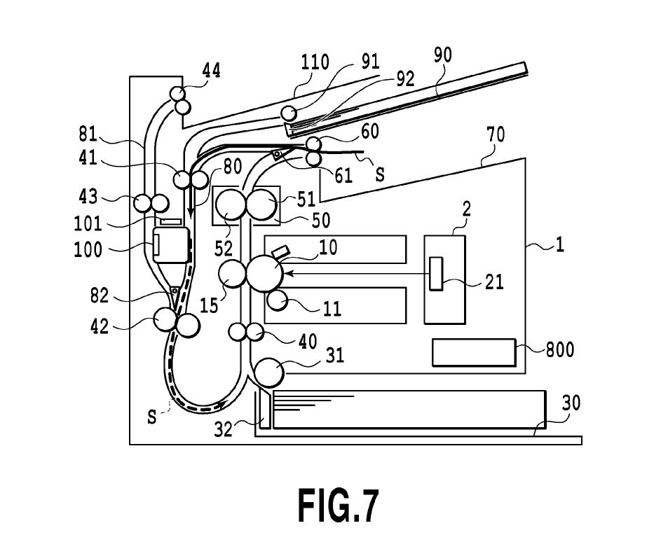

FIG. 7 is a diagram for explaining image formation of the first side in the document. After the rear end of the print sheet S on which the image formation of the second side in the document is completed passes the both-side flapper 61, the both-side flapper 61 switches the conveying path. After that, the discharge roller 60 starts to rotate reversely to convey the print sheet S to the both-side conveying path 80. The print sheet S conveyed to the both-side conveying path 80 passes the image reading component 100, which is conveyed to the conveying roller 40 by the conveying roller 42, and is conveyed to the transfer component 15 by the conveying roller 40. In FIG. 7, an arrow of a broken line shows the state. The light emitting component 21 emits laser rays on the surface of the photoconductive drum 10 based upon the image information of the first side of the document G stored in the image memory 804, and the latent image is formed on the surface of the photoconductive drum 10 based upon the image information of the first side of the document G. The transfer component 15 transfers the toner image formed by the latent image to the print sheet S, the fixing component 50 fixes the toner image to the print sheet S, and the image formation based upon the image information of the first side in the document G is completed. After that, the print sheet S is loaded on the first discharge component 70.

Hereinafter, components involved in the printing, such as the photoconductive component 10, the developing roller 11, the transfer component 15, and the fixing component 50 are collectively called a printing component.

<Hardware Configuration of Image Forming Apparatus>

FIG. 8 is a diagram showing hardware of the image forming apparatus 1. In addition, an electric component 800 in the image forming apparatus 1 will be explained with reference to FIG. 8. In FIG. 8, respective components controlled by a control CPU 801 (hereinafter, CPU 801) are described.

The control CPU 801 connects the light emitting component 21 including a polygon mirror, a motor, a laser rays emitting element and the like through an ASIC 802. For forming a desired latent image by scanning the surface of the photoconductive drum 10 with laser rays, the control CPU 801 sends a control signal to the ASIC 802 to control the light emitting component 21. The control CPU 801, for conveying the print sheet S, sends a control signal to the ASIC 802 to control a drive system such as a main motor 830, a CST feeding solenoid 822, a both-side driving motor 840, and a CIS feeding solenoid 823. The main motor 830 drives the CST pickup roller 31, the conveying roller 40, the photoconductive drum 10, the transfer component 15, the heating roller 51, the pressure roller 52 and the like. The CST feeding solenoid 822 switches on at a drive start time of the feeding roller for feeding the print sheet S to convey torque of the main motor 830 to the CTS pickup roller 31. The both-side driving motor 840 drives the pickup roller 91 and the conveying rollers 41 to 44. The CST feeding solenoid 823 switches on at a drive start time of the feeding roller for feeding the document G to convey torque of the both-side driving motor 840 to the CIS pickup roller 91.

The control CPU 801 controls the high-voltage power source unit 810 for controlling operations of charging, developing, transferring and the like required for an electronic photo process, and the low-voltage power source unit 811 for controlling the fixation. Further, the control CPU 801 monitors a temperature by a thermistor (not shown) provided in the fixing component 50 to perform control of keeping the fixing temperature to be constant.

The control CPU 801 is connected to a program memory 803 through a bus or the like. Programs and data for executing all or a part of processes to be executed by the control CPU 801 are stored in the program memory 803. That is, the control CPU 801 executes processes to be hereinafter explained by using the programs and data stored in the program memory 803.

The ASIC 802 performs speed control of a motor in the optical component 21, speed control of the main motor 830, and speed control of the both-side driving motor 840 based upon an instruction of the control CPU 801. In the speed control of the motor, a tuck signal from the motor is detected, and an acceleration signal or a deceleration signal is sent to the motor such that an interval between the tuck signals becomes a predetermined time. The tuck signal indicates a pulse signal that is output from the motor each time the motor rotates. Use of the ASIC 802 brings in an advantage that a reduction in control load of the control CPU 801 can be achieved.

The control CPU 801 is connected to an operating component 805. The operating component 805 has a display component such as a touch panel, and operating keys. The control CPU 801 controls the operating component 805 in such a manner as to display an operation screen and receives an instruction from a user through the operating component 805.

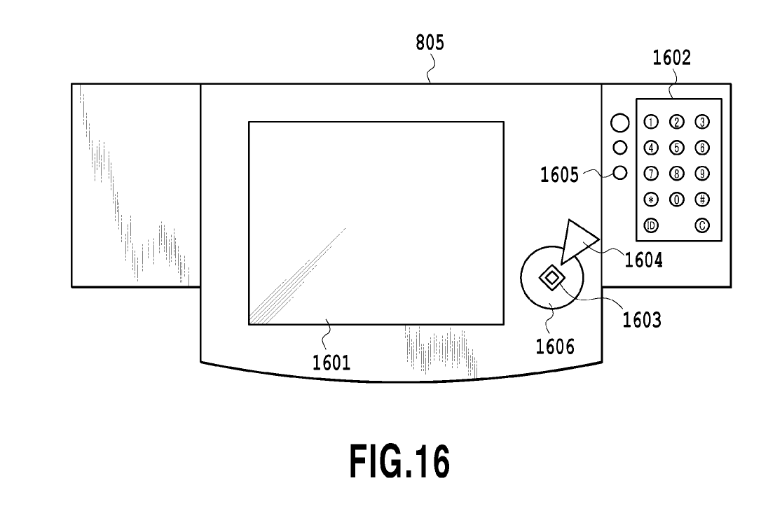

FIG. 16 is a diagram showing an example of the operating component 805. The operating component 805 has a display component 1601. The display component 1601 is configured by a liquid-crystal display on which a touch panel sheet is applied, and displays the operation screen and software keys. The display component 1601 sends, as the software key is pushed down, position information showing the pushed-down position to the control CPU 801. The control CPU 801 determines an instruction of a user based upon the position information.

The operation component 805 further has a numerical key pad 1602, a stop key 1604, user mode keys 1605, and a start key 1606. The numerical key pad 1602 is a key for inputting numerical numbers and characters, and is used in setting the copying number or switching a screen. The stop key 1604 is a key for stopping the operation in the middle of working. The user mode key 1605 is a key for performing the setting of the image forming apparatus 1. The start key 1606 is a key for instructing start of the reading of an image or start of a print.

A two-color LED 1603 is provided in the center of the start key 1606. In a case where the LED 1603 is in green color, it indicates that use of the start key 1606 is enabled. In a case where the LED 1603 is in red color, it indicates that use of the start key 1606 is not enabled.

The control CPU 801 drives, in a case of receiving an instruction of a copy from the operating component 805 or in a case of receiving a print command from the host computer, the main motor 830 and the both-side driving motor 840 to convey a print sheet. A toner image formed on the surface of the photoconductive drum 10 is transferred to the print sheet by the transfer component 15, and after the toner image is fixed on the print sheet S by the fixing component 50, the print sheet is discharged to the first discharge component 70. For enhancing alignment of the print sheet on which the image formation is already performed, a gradual going-up gradient is formed in the first discharge component 70 from the vicinity of the discharge port toward the discharge direction of the print sheet. The control CPU 801 controls the low-voltage power source unit 811 in such a manner as to supply a predetermined power to the fixing component 50, and the fixing component 50 generates a predetermined thermal calories and gives the generated calories to the print sheet to melt the toner image on the print sheet, thus fixing the toner image on the print sheet.

The control CPU 801 drives, in a case of receiving an instruction of a copy from the operating component 805 or in a case of receiving a scan command from the host computer, the both-side driving motor 840. The torque of the both-side driving motor 840 is transmitted to the CIS pickup roller 91, and the CIS pickup roller 91 conveys the document. The image reading component 100 is connected to the ASIC 802 through signal lines 902, 903, 910, 912, 913, and 914. The ASIC 802 controls the image reading component 100 according to an instruction of the control CPU 801, and stored the image information read by the image reading component 100 in the image memory 804.

FIG. 9 is a diagram for explaining the details of the image reading component 100. As shown in FIG. 9, a contact image sensor (hereinafter, CIS) is used in the image reading component 100. Here, in the CIS 901, for example, photodiodes of 10368 pixels are arranged at a specific main scan resolution (for example, 1200 dpi) in an array shape.

The image reading component 100 receives a start pulse signal (CISSTART) 902, a light-emitting element control signal (CISLED) 903, an S1_in signal 912, an S1_select signal 913, and a system clock (SYSCLK) 914 for determining an operation speed of the CIS. In addition, the image reading component 100 sends an S1_out signal 910.

The light emitting element 907 emits light based upon current amplified by a current amplifying component 906, and uniformly emits light on the document G facing the CIS 901.

In a case where the CISSTART signal 902 becomes active, the CIS 901 starts accumulation of electric charges based upon the received light, and sets data to an output buffer 904 in order. As the transfer clock (CISCLK) 915 (for example, from 500 kHz to 1 MHz) is given to the shift resister 905, the shift resister 905 transfers the data set to the output buffer 904 to an A/D converter 908 as a CISSNS signal 918.

Since the CISSNS signal 918 is provided with a predetermined data safeguard area, the CISSNS signal 918 is sampled after a predetermined time elapses from the rising timing of the transfer clock 915. The CISSNS signal 918 is output in synchronization with both of rising and falling edges of the transfer clock 915. Frequency of a CIS sampling clock (ADCLK) 916 determining a sampling speed of the A/D converter is generated to be twice the transfer clock 915. In addition, the CISSNS signal 918 is sampled at the rising edge of the CIS sampling clock 916. A timing generator 917 frequency-divides a system clock 914 to generate the CIS sampling clock 916 and the transfer clock 915. The phase of the CIS sampling clock 916 is delayed by the data safeguard area as compared to the transfer clock 915.

The CISSNS signal 918 subjected to digital conversion by the A/D converter 908 is sent as the S1_out signal 910 at predetermined timing by an output interface circuit 909. The S1_out signal 910 is serial data. At this time, since the CISSNS signal 918 corresponding to a predetermined pixel number from the CISSTART signal 902 is an analogue voltage output reference voltage, it is not used as an effective pixel.

The control circuit 911 can variably control an A/D conversion gain of the A/D converter 908 according to the S1_in signal 912 and the S1_select signal 913. For example, in a case where contrast of a captured image cannot appropriately be obtained, the control CPU 801 instructs the control circuit 911 in such a manner as to increase the A/D conversion gain of the A/D converter 908 for increasing the contrast. Therefore it is possible to capture an image with the best contrast.

In FIG. 9, an explanation is made of an example where all the pixels are output as the CISSNS signal 918 one by one. For reading the image in high speeds, however, plural pixels are divided for each area, and the plural areas may be subjected to A/D conversion in parallel. In addition, in FIG. 9, the CIS is used in the image reading component 100. A CMOS sensor or a CDD sensor may be, however, used in the image reading component 100.

<On-Printing Process>

The image forming apparatus in the present embodiment has the conveying path which enables a print to be performed directly on the read document. Therefore the process (on-printing process) in which both sides of the document are read and image formation is performed on both the sides of the read document is enabled.

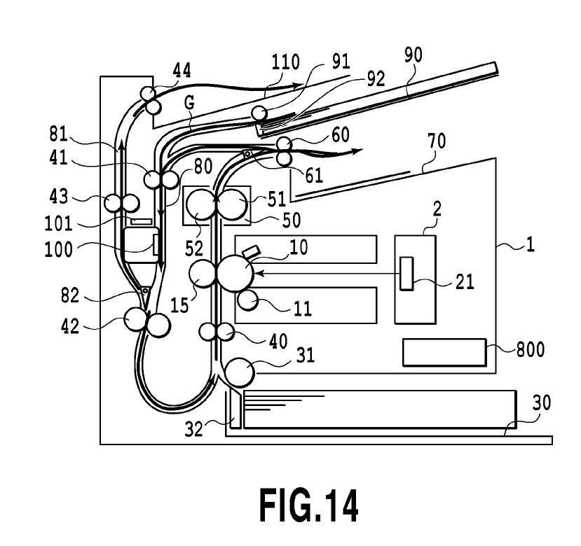

FIG. 14 is a diagram for explaining the on-printing process.

As the control CPU 801 as the control unit in the image forming apparatus 1 receives an on-printing command and a print content instructed from the host computer (not shown), the control CPU 801 stores the print content in the image memory 804 to start the on-printing process.

The documents G accommodated in the second feeding component 90 are conveyed to the conveying roller 41 one by one by the CIS pickup roller 91 and the separation unit 92. On the other hand, the image reading component 100 performs light emission on the white reference member 101 and correction of a white reference value before starting the reading of the first side as a document front side in the document G fed from the second feeding component 90, and after that, the image reading component 100 rotates to a position of facing the both-side conveying path 80. The conveying roller 41 conveys the document G to the image reading component 100. The image reading component 100 already waits in the position of facing the both-side conveying path 80, and the information read by the image reading component 100 is stored in the image memory 804 in FIG. 8 as information of the first side of the document.

he document G which has passed the image reading component 100 is conveyed to the conveying roller 42. The conveying roller 42 stops at a point where the rear end of the document G passes the switch back flapper 82. Therefore the document G stops in a state of being interposed and held between the conveying rollers 42. After a predetermined time elapses, the document G is conveyed to a document conveying path 81.

At the same time the switch back flapper 82 switches the conveying path from the both-side conveying path 80 to the document conveying path 81, the image reading component 100 rotates to the position of facing the document conveying path 81. As the conveying roller 42 reversely rotates, the document G is conveyed to the image reading component 100 along the document conveying path 81. In a case where the document G is conveyed to the image reading component 100 for the passing, the information of the second side as the document back side is read, and is stored in the image memory 804 as the information of the second side in the document.

The document G in which the image reading is finished is conveyed to the conveying rollers 43 and 44. The conveying roller 44 stops at a point where the rear end of the document G passes the image reading component 100. Therefore the document G stops in a state where the document G is interposed and held between the conveying rollers 44. As the conveying roller 44 reversely rotates after a predetermined time elapses, the document G is conveyed to the conveying roller 42 and the conveying roller 40 along the document conveying path 81. The conveying roller 40 conveys the document G to the transfer component 15 such that the toner image on the surface of the photoconductive drum 10 and the front end position of the document G are in agreement in timing.

The toner image conveyed to the transfer component 15 with rotation of the photoconductive drum 10 is transferred to the document G by an applied bias and a pressure applied to the transfer component 15. The transfer component 15 further conveys the document G to the fixing component 50. In the fixing component 50, the heat from the rotatable heating roller 51 and the pressure of the rotatable pressure roller 52 facing the heating roller 51 fix the toner image on the document G.

The document G on which the toner image is fixed is conveyed to the discharge roller 60. The discharge roller 60 stops at a point where the rear end of the document G passes the both-side flapper 61, and the both-side flapper 61 switches the conveying path such that the document G is conveyed in a direction of the conveying roller 41. As the discharge roller 60 reversely rotates after a predetermined time elapses, the document G is conveyed to the conveying roller 41. Subsequently the document G is conveyed to the conveying roller 42, the conveying roller 40, the transfer component 15, and the fixing component 50 for a print. After that, the document G is conveyed to the discharge roller 60, and the discharge roller 60 conveys the document G outside of the apparatus as it is, and the document G is loaded on the first discharge component 70.

The document is thus read, and the image formation is performed on both sides of the read document.

Next, an explanation will be made of a process of performing a one-side print by reusing the backing sheet as an example of the on-printing process (hereinafter, backing sheet one-side printing process). Here, the backing sheet may be a sheet which has once been used, on a first side and/or a second side of which an image or the like has been written or a sheet which has not been used, on both sides of which nothing is written. The backing sheet (used sheet) is placed on the second feeding component 90 accommodating documents for performing a backing sheet one-side printing process. In the backing sheet one-side printing process, the image forming apparatus 1 reads one side or both sides of the backing sheet with the aim of the one-side print, and determines a side of a white sheet or a usable blank area from the image information of the read backing sheet. In a case where the backing sheet has the side of the white sheet or the usable blank area, the one-side print is performed, and if not, the next backing sheet is read.

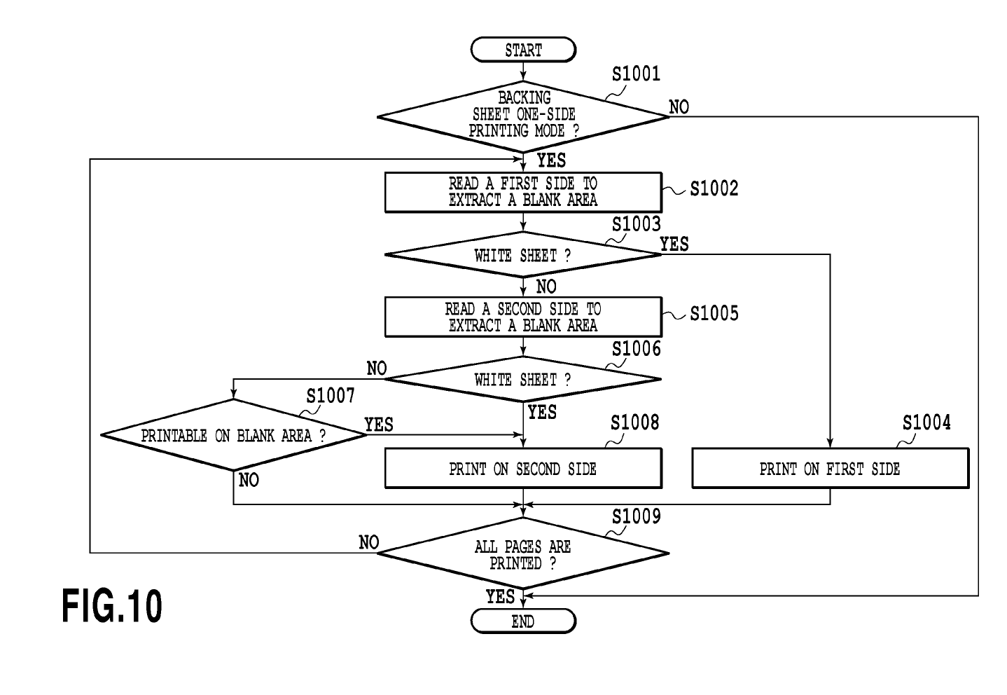

FIG. 10 is a flow chart of a backing sheet one-side printing process according to the present embodiment. An explanation will be made of an operation of the control CPU 801 as the control unit in the image forming apparatus 1 with reference to the flow chart in FIG. 10.

As the control CPU 801 receives a print command and a print content instructed from the host computer (not shown), the print content is stored in the image memory 804. In a case where the print command is an instruction of the backing sheet one-side printing process, the backing sheet one-side printing process starts. Hereinafter, the details of the backing sheet one-side printing process will be explained.

At step S1001, the control CPU 801 determines whether or not a command instructed by the host computer is a backing sheet one-side printing mode. The instruction of the command may be an instruction by a panel of the main body other than the instruction by the host computer.

In a case where the command is not the backing sheet one-side printing mode, the control CPU 801 determines that the command is a regular one-side printing mode, and is performed such that, as explained in FIG. 1, a sheet is conveyed from the first feeding component 30 to print thereon in the printing component and the sheet is discharged to the first discharge component 70 by the discharge roller 60. An explanation is herein made of a case of one page of the one-side printing process in regard to the mode other than the backing sheet one-side printing mode, but any process such as both-side print or both-side scan may be performed.

In a case where the command is the backing sheet one-side printing mode, the process goes to step S1002.

At step S1002, the control CPU 801 is performed such that a first side of a document (used sheet) is read, and a blank area is extracted from the read document image. The detailed operation is performed as explained with reference to FIG. 14. The document G accommodated in the second feeding component 90 is conveyed, the document image is read by the image reading component 100, and the read document image is stored in the image memory 804. Next, the control CPU 801 counts the pixel number other than the white pixel in the document image in one lateral line, and distinguishes between an area where an object exists and a blank area to extract the blank area.

Next at step S1003 the control CPU 801 determines whether or not the first side of the read document is a white sheet. Any method may be adopted, for example, it is determined as the white sheet in a case where the blank area extracted at step S1002 is formed across the entire sheet. Further, even if more or less dusts exist thereon, the first side may be determined as the white sheet. In a case of the white sheet, the process goes to step S1004. In a case where the first side is not the white sheet, the process goes to step S1005.

The on-printing process on both the sides is explained in FIG. 14, but since a print is herein performed on one side alone, it is not required to read an image of the second side in a case where the first side is the white sheet. The document G having passed the image reading component 100 is conveyed to the conveying roller 42. The conveying roller 42 stops at a point where the rear end of the document G passes the switch back flapper 82. Therefore the document G stops in a state where the document G is interposed and held between the conveying rollers 42. In a case where at step S1003 it is determined that the first side is the white sheet, since the image reading of the second side is not required, the document G is not conveyed to the document conveying path 81, but is conveyed to the conveying roller 40 by the conveying roller 42.

At step S1004 the control CPU 801 is performed such that the print content stored in the image memory 804 is printed on the first side in the document, and next the process goes to step S1009.

On the other hand, in a case where the first side is not the white sheet, the image reading of the second side is required also in the on-printing process onto one side. In FIG. 14, the document G which has passed the image reading component 100 is conveyed to the conveying roller 42. The conveying roller 42 stops at a point where the rear end of the document G passes the switch back flapper 82. Therefore the document G stops in a state of being interposed and held between the conveyed rollers 42. In a case where at step S1003 it is determined that the first side is not the white sheet, the switch back flapper 82 switches the conveying path from the both-side conveying path 80 to the document conveying path 81, and at the same time, the image reading component 100 rotates to a position of facing the document conveying path 81. The conveying roller 42 reversely rotates to convey the document to the document conveying path 81, and the second side is read by the image reading component 100, which is stored in the reading image memory 804 to extract the blank area.

At step S1005 the control CPU 801 is performed in such a manner as to read the second side of the document, and extract the blank area from the read document image as similar to step S1002.

At step S1006 the control CPU 801 determines whether or not the second side of the read document is a white sheet. The control CPU 801 determines that the second side is the white sheet in a case where the blank area extracted at step S1005 is formed across the entire sheet surface. In a case where the second side is not the white sheet, the process goes to step S1007. In a case where the second side is the white sheet, the process goes to step S1008.

At step S1007 it is determined whether or not a print can be performed on the blank area by comparing the blank area extracted at step S1005 with an area of the print content stored in the image memory 804. In a case where the print on the blank area is enabled, the process goes to step S1008. In a case where the print is not enabled, the process goes to step S1009.

At step S1008 the control CPU 801 is performed to perform a print on the second side. The document the second side of which is read at step S1003 is conveyed to the conveying rollers 43 and 44. The conveying roller 44 stops at a point where the rear end of the document G passes the image reading component 100. Therefore the document G stops in a state where the document G is interposed and held between the conveying rollers 44. As the conveying roller 44 reversely rotates after a predetermined time elapses, the document G is conveyed to the conveying roller 42 and the conveying roller 40 along the document conveying path 81. Since a print is not performed on the first side, the conveying roller 40 conveys the sheet to the discharge roller 60 as it is, but the print component does not perform any operation. The discharge roller 60 stops at a point where the rear end of the document G passes the both-side flapper 61, and the both-side flapper 61 switches the conveying path such that the document G is conveyed in a direction of the conveying roller 41. As the discharge roller 60 reversely rotates after a predetermined time elapses, the document G is conveyed to the conveying roller 41. Subsequently the document G is conveyed to the conveying roller 42, the conveying roller 40, the transfer component 15, and the fixing component 50 for a print. Next, the process goes to step S1009.

At step S1009 the control CPU 801 determines whether or not all the pages of the print content are printed. In a case where the print of all the pages is completed, the backing sheet one-side printing process finishes. In a case where the page of the print content to be printed is yet left, the process goes to step S1002, wherein the printing process likewise continues to be executed.

As explained above, it is possible to provide the image forming apparatus in which even if the backing sheet is placed in any position as a document to be read, a print can be performed on the white sheet side of the backing sheet and the blank area of the opposing side. That is, according to the image forming apparatus in the present embodiment, it is possible to correctively print on the white sheet side even if the white sheet side is not aligned at the time of printing by reuse of the backing sheet, and it is possible to save the sheet by printing also on the blank area.

It should be noted that according to the above-mentioned explanation, in a case where the second side of the document is not the white sheet, it is determined whether or not a print is enabled, and if enabled, the print is performed, but step S1007 for determining whether or not the print is enabled on the blank area of the second side may be omitted. That is, in a case where it is determined that the second side of the document is not the white sheet, it may be determined that the print is not performed on the second side without determining whether or not the print is enabled on the blank area of the second side.

### Embodiment 2

The backing sheet one-side printing process is executed in Embodiment 1, but in the present embodiment, a both-side print (hereinafter, backing sheet both-side printing process) is performed by reuse of the backing sheet. In the backing sheet both-side printing process, the image forming apparatus 1 reads both sides of the backing sheet with the aim of the both-side print, and determines a side of the white sheet or a usable blank area from image information of the read backing sheet. The side which is the white sheet or has the usable blank area is determined to be usable. In a case where both sides are usable, the both-side print is performed, and in a case where only the one side is usable, the one-side print is performed. In a case where both the sides are not usable, the next backing sheet is read.

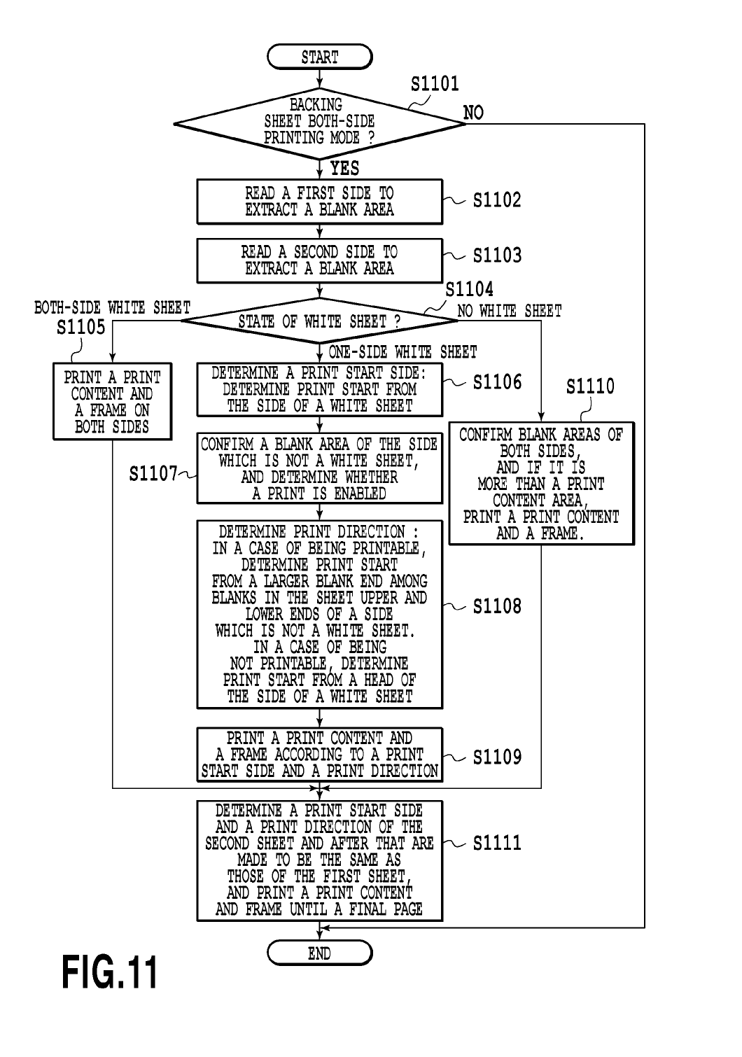

FIG. 11 is a flow chart of the both-side printing process in the present embodiment. An explanation will be made of an operation of the control CPU 801 as the control unit in the image forming apparatus 1 with reference to the flow chart in FIG. 11.

As the control CPU 801 receives a print command and a print content instructed from the host computer (not shown), the print content is stored in the image memory 804. In a case where the print command is an instruction of the backing sheet both-side printing process, the backing sheet both-side printing process starts. Hereinafter, the details of the backing sheet both-side printing process will be explained.

At step S1101, the control CPU 801 determines whether or not the command instructed by the host computer is a backing sheet both-side printing mode. The instruction of the command may be an instruction by a panel of the main body other than the instruction by the host computer.

In a case where the command is not the backing sheet both-side printing mode, the control CPU 801 determines that the command is a regular one-side printing mode, and is performed such that, as explained in FIG. 1, the sheet is conveyed from the first feeding component 30 to print in the printing component, which is discharged to the first discharge component 70 by the discharge roller 60. An explanation is herein made of a case of one page of the one-side printing process in regard to the mode other than the backing sheet both-side printing mode, but any process such as both-side print or both-side scan may be adopted.

In a case where the command is the backing sheet both-side printing mode, the process goes to step S1102.

At step S1102, the control CPU 801 is performed such that a first side of a document (backing sheet from the second feeding component 90) is read, the read document image is stored in the image memory 804, and a blank area of the first side in the document is extracted.

Next, at step S1103 the control CPU 801 is performed such that a second side of the document is read, the read document image is stored in the image memory 804, and a blank area is extracted from the document image.

These processes are the same processes as those at step S1002 and at step S1005 in Embodiment 1.

Next at step S1104 a state of a white sheet in each of the first side and the second side is determined as similar to step S1003 and step S1006 in Embodiment 1. In a case where both the sides are the white sheets, the process goes to step S1105, and in a case where the one side is the white sheet, the process goes to step S1106. In a case where neither of the sides is not the white sheet, the process goes to step S1109.

At step S1105 the control CPU 801 is performed such that a print content of the first page in the image memory 804 and a double frame surrounding it are printed on the first side and a print content of the second page in the image memory 804 and a double frame surrounding it are printed on the second side. These double frames are marks for distinguishing between the unnecessary print area printed on the sheet in the past and the area printed newly at step S1108 to be able to be easily seen. For the distinction, in addition to the frame, changing attributes such as color or font in printing, filling the unnecessary portion already printed on the sheet with black or attaching a mark of elimination or a strike-through thereto may be made.

At step S1106 the control CPU 801 determines that a side of the white sheet is a print start side on which the first page in the image memory 804 is printed. For example, in a case where the first side is the white sheet, the first page in the image memory 804 is printed on the first side, and the second page in the image memory 804 is printed on the second side. In reverse, in a case where the second side is the white sheet, the first page in the image memory 804 is printed on the second side, and the second page in the image memory 804 is printed on the first side.

At step S1107 the control CPU 801 determines whether or not a print can be performed on a blank area of a side which is not the white sheet. Specifically in a case where a sheet upper end or a sheet lower end of the side which is not the white sheet, which has a larger blank area, is more than a print content area of the second page in the image memory 804, the control CPU 801 determines that the print can be performed on the blank area of the side which is not the white sheet. In a case where the blank area is smaller than the print content area of the second page, the control CPU 801 determines that the print can not be performed on the blank area of the side which is not the white sheet.

At step S1108 the control CPU 801 determines a print direction.

In a case where a print can be performed on the blank area of the side which is not the white sheet, the control CPU 801, in regard to a print direction at the time of printing on both sides composed of the side which is the white sheet and the side which is not the white sheet, determines that the print starts from a sheet end, having a larger blank area, of the side which is not the white sheet.

This determination of the print direction has the following advantage. First, a print is performed from the upper end to the lower end of the sheet at the time of printing as usual, and there are many cases where the blank area in the lower end is large. In this case, at the time of printing by reuse of the backing sheet, as a print starts from a blank end of the larger blank area, the print direction becomes a direction at the opposite to the direction where the print was performed on the sheet in the past, and it is easier to distinguish between an area to be newly printed and the unnecessary print area printed on the sheet in the past. Second, as described later at step S1111, the print direction of the second sheet and sheets after that is set to be the same as that of the first sheet. There are many cases where sheets of the second sheet of the backing sheet and after that are placed in the same direction as that of the first sheet. In this case, at the time of determining a blank area of each of the sheets of the second sheet and after that, a blank side having a larger blank area and a print content area can be compared as similar to the first sheet, and thereby it is possible to perform many prints on sheets of the second sheet and after that. In addition, at the time of performing a print on sheets of the second and after that, the print direction, as similar to the first sheet, becomes a direction at the opposite to the direction where the print was performed on the sheet in the past, and it is easier to distinguish between an area to be newly printed and the unnecessary print area printed on the sheet in the past.

In a case where a print can not be performed on the blank area of the side which is not the white sheet, the control CPU 801, in regard to the print direction at the time of performing a print on the side of the white sheet, determines that the print starts from a head of the side in the white sheet.

Next, at step S1109 the control CPU 801 is performed such that a print content and a frame are printed according to the print start side and the print direction.

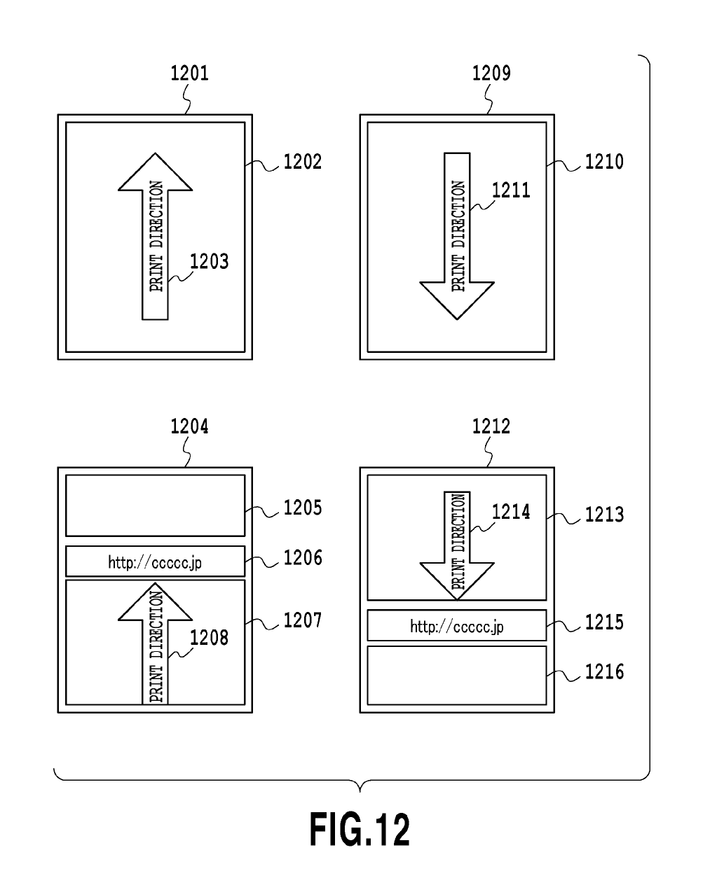

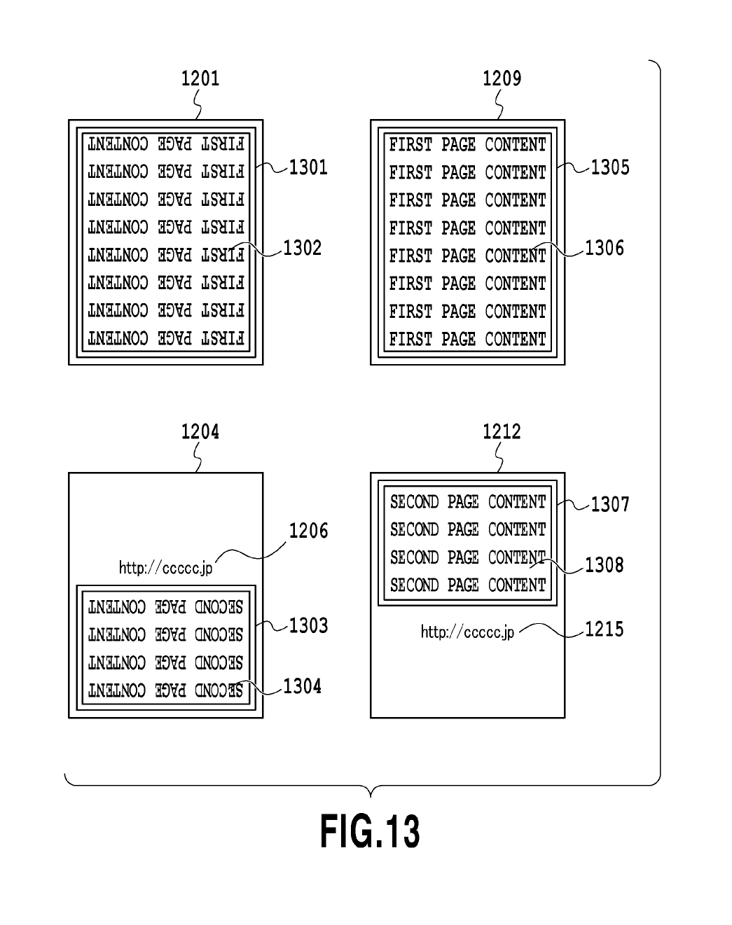

A specific explanation in regard to the determination and print of the print start side and the print direction will be made with reference to FIG. 12 and FIG. 13.

n example of a first side 1201 and a second side 1204 will be explained. A blank area of the first side 1201 is indicated at 1202, and is determined to be a white sheet since it is formed across an entire sheet. In the second side 1204, an area on which a print is already performed is indicated at 1206, and blank areas are provided in a sheet upper end indicated at 1205 and in a sheet lower end indicated at 1207. Since at step S1106 the first side 1201 is the white sheet and the second side 1204 is not white sheet, the print start side is determined to be the first side 1201. That is, the first page of the print content is printed on the first side. Next, at step S1107 the larger blank among the sheet upper and lower ends in the second side 1204 is determined to be the blank area 1207 in the sheet lower end. The blank area 1207 and the print content area of the second page of the print content are compared in size. In a case where the blank area 1207 is larger, it is determined that a print can be performed on the blank area 1207. Since at step S1108 the blank area 1207 is the sheet lower end, the print direction is determined to be a direction 1208 of going from lower to upper. For coordinating with it, the same direction 1203 of going from lower to upper is determined to be the print direction also in the first side. In a case where the blank area 1207 is smaller than the print content area, a print is not performed on the second side 1204. The second page of the print content is printed on the next sheet. The print direction of this case is made to print from the head of the first side as usual.

FIG. 13 shows a state of being actually printed. The first page of the print content stored in the image memory 804 is printed on the first side 1201 in the form of being rotated at an angle of 180 degrees, which is indicated at 1302. Further, a double frame 1301 is printed in such a manner as to surround it. Likewise the second page of the print content stored in the image memory 804 is printed on the second side 1204 in the form of being rotated at an angle of 180 degrees, which is indicated at 1304. Further, a double frame 1303 is printed in such a manner as to surround it.

Another specific explanation in regard to the determination and print of the print start side and the print direction will be made.

An example of a first side 1209 and a second side 1212 will be explained. A blank area of the first side 1209 is indicated at 1210, and is determined to be a white sheet since it is formed across an entire sheet. In the second side 1212, an area on which a print is already performed is indicated at 1215, and blank areas are provided in a sheet upper end indicated at 1213 and in a sheet lower end indicated at 1216. Since at step S1106 the first side 1209 is the white sheet and the second side 1212 is not white sheet, the print start side is determined to be the first side 1209. That is, the first page of the print content is printed on the first side. Next, at step S1107 the larger blank among the sheet upper and lower ends in the second side 1212 is determined to be the blank area 1213 in the sheet upper end. The blank area 1213 and a print content area of the second page of the print content are compared in size. In a case where the blank area 1213 is larger, it is determined that a print can be performed on the blank area 1213. Since at step S1108 the blank area 1213 is the sheet upper end, the print direction is determined to be a direction 1214 of going from upper to lower. For coordinating with it, the same direction 1211 of going from upper to lower is determined to be the print direction also in the first side. In a case where the blank area 1213 is smaller than the print content area, a print is not performed on the second side 1212. The second page of the print content is printed on the next sheet. The print direction of this case is made to print from the head of the first side as usual.

FIG. 13 shows a state of being actually printed. The first page of the print content stored in the image memory 804 is printed on the first side 1209 as it is, which is indicated at 1306. Further, a double frame 1305 is printed in such a manner as to surround it. Likewise the second page of the print content stored in the image memory 804 is printed on the second side 1212 as it is, which is indicated at 1308. Further, a double frame 1307 is printed in such a manner as to surround it.

It should be noted that a specific example of the image reading of both sides, and the conveying, reading and printing of a sheet in regard to printing on both the sides are as explained with reference to FIG. 14.

Next an explanation will be made of an example where at step S1104 both the sides are determined to be not the white sheet and the process goes to step S1110.

At step S1110 the control CPU 801 is performed such that the blank area of each of both the sides is confirmed, and in a case where the blank area is more than the print content area, the print content and the frame are printed. In regard to the print start side, since neither of the sides is the white side, the first side is set as a start side. In regard to the print direction, a print is performed from the sheet upper end. Blank areas on the first side are compared in size, and the largest blank area is extracted. The blank area and the print content area of the first page of the print content in the image memory 804 are compared in size. In a case where the blank area is larger, the print content is printed. In addition, the double frame is printed to surround it. Likewise in a case where the blank area is larger than the print content area also in regard to the second side, the print content and the double frame are printed. In a case where the blank area is smaller than the print content, a print is not performed on that side.

At step S1111, the print start side and the print direction are made to be the same as those in the first sheet in regard to sheets of the second sheet and after that. A print of the print content and the frame is performed until the final page to complete the backing sheet both-side printing process.

As explained above, as similar to Embodiment 1, even how the backing sheet is placed as the reading document, it is possible to provide the image forming apparatus in which a print can be performed on the white sheet side of the backing sheet and the blank area of the opposite side. Further, in the image forming apparatus in the present embodiment, the print direction to the first sheet of the backing sheet is determined such that a print starts from the blank side of the side which is not the white sheet, having a larger blank area, and the print direction to sheets of the second sheet and after that is the same as that of the first sheet. Thereby it is easier to distinguish between an area to be newly printed and the unnecessary print area printed on the sheet in the past, and the image forming apparatus in the present embodiment has the effect that many prints can be performed on sheets of the second sheet and after that.

### Embodiment 3

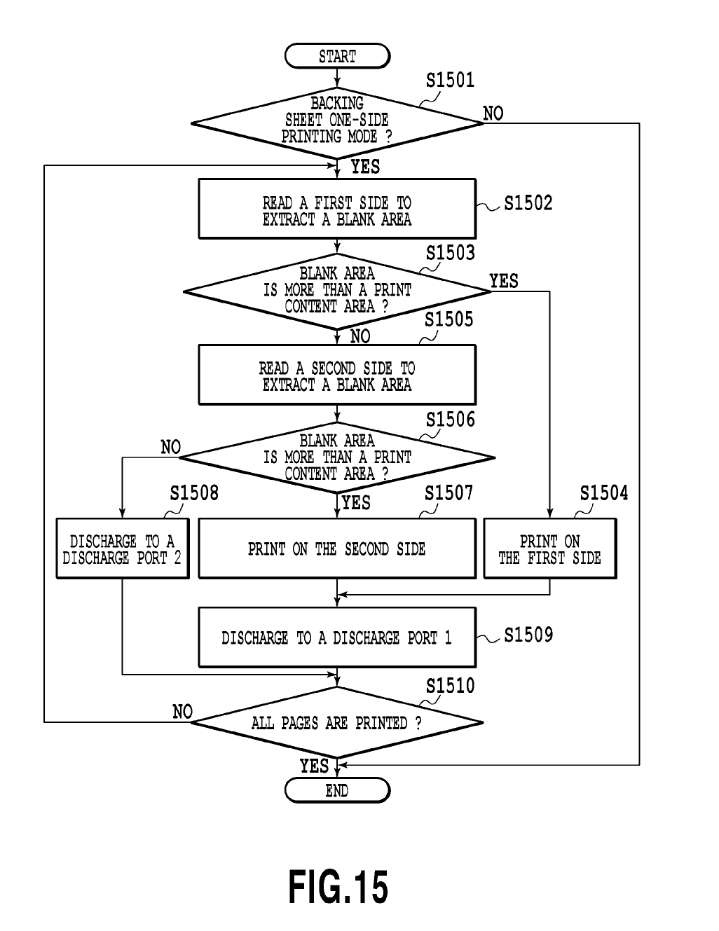

In Embodiment 1 and Embodiment 2, the printed sheet and the sheet on which the print is unable are discharged to the same discharge port, but in the present embodiment, a discharge port to the printed sheet is automatically separated from a discharge port to the sheet on which the print is unable for sorting. For example, the first discharge component 70 may be separated from the second discharge component 110. FIG. 15 is a flow chart of an on-printing process in the present embodiment. An explanation will be made of an operation of the control CPU 801 as the control unit in the image forming apparatus 1 according to the flow chart in FIG. 15.

As the control CPU 801 receives a backing sheet one-side printing command and a print content instructed from the host computer (not shown), the print content is stored in the mage memory 804, and the on-printing process starts. In a case where the command received from the host computer is an instruction of the backing sheet one-side printing process, a blank area of the read document is extracted, and the print content is printed on the white sheet side, which is discharged to a discharge port 1. In a case where the blank area on each of both sides is smaller than the print content and the print is enabled thereon, the sheet is discharged to a discharge port 2. Hereinafter, an explanation will be made of the details of the backing sheet one-side printing process in the present embodiment.

At step S1501 the control CPU 801 determines whether or not the command instructed from the host computer is the backing sheet one-side printing process. The instruction of the command may be an instruction by the panel of the main body other than the instruction from the host computer.

In a case where the instructed command is not the backing sheet one-side printing process, the control CPU 801 determines that the instructed command is a regular one-side printing mode, and as explained in FIG. 1, is performed such that the sheet is conveyed from the first feeding component 30, on which a print is performed in the printing component, and is discharged to the first discharge component 70 by the discharge roller 60. An explanation is herein made of a case of one page of the one-side printing process in regard to the mode other than the backing sheet one-side printing mode, but any process such as both-side print or both-side scan may be applied.

In a case where the instructed command is the backing sheet one-side printing mode, the process goes to step S1502.

At step S1502, the control CPU 801 is performed such that a first side of a document is read, and a blank area is extracted from the read document image. The detailed operation is performed as explained with reference to FIG. 14. The document G accommodated in the second feeding component 90 is conveyed, which is read by the image reading component 100, and the read document image is stored in the image memory 804. Next, the control CPU 801 counts the pixel number other than the white pixel in the document image in a one-lateral line direction, and distinguishes between areas where objects exist and blank areas to extract the blank areas. Subsequently the largest blank area among them is extracted to be set as a blank area on the first side.

Next at step S1503 the control CPU 801 determines whether or not the blank area of the first side of the read document is more than the print content area of the first page stored in the image memory 804. In a case where the blank area is larger than the print content area, the process goes to step S1504. In a case where the blank area is smaller than the print content area, the process goes to step S1507.

At step S1504 the control CPU 801 is performed such that the print content of the first page stored in the image memory 804 is printed on the blank area of the first side, and the process goes to step S1509. The image reading and printing of the sheet following the process explained until here, and the conveying method of the sheet following the printing are the same as the method in the explanation of the flow chart in FIG. 10 in Embodiment 1, which is made with reference to FIG. 14.

At step S1505, the control CPU 801 is performed such that a second side of the document is read. The detailed operation is performed as explained with reference to FIG. 14. Next, the control CPU 801 counts the pixel number other than the white pixel in the document image in a one-lateral line direction, and distinguishes between areas where objects exist and blank areas to extract the blank areas. Subsequently the largest blank area among them is extracted to be set as a blank area on the second side.

Next, at step S1506 the control CPU 801 determines whether or not the blank area on the second side is more than the print content area. Since the print content of the first page stored in the image memory 804 is not yet printed herein, the print content area of the first page and the blank area on the second side are compared in size. In a case where the blank area is larger, the process goes to step S1507. In a case where the blank area is smaller, the process goes to step S1508.

At step S1507 the control CPU 801 is performed such that the print content of the first page stored in the image memory 804 is printed on the blank area of the second side, and the process goes to step S1509.

At step S1508 the control CPU 801 is performed such that the document on which the print is not performed at all is discharged to the discharge port 2, and the process goes to step S1510.

At step S1509 the control CPU 801 is performed such that the document on which the print is finished is discharged to the discharge port 1, and the process goes to step S1510.

At step S1510 the control CPU 801 determines whether or not all the pages of the print content are printed. In a case where the print of all the pages is completed, the backing sheet one-side printing process finishes. In a case where the page of the print content to be printed is yet left, the process goes to step S1502, wherein the printing process likewise continues to be executed.

As explained above, as similar to Embodiment 1, even how the backing sheet is placed as the reading document, a print can be performed on the white sheet side of the backing sheet and the blank area of the opposite side. In addition, it is possible to provide the image forming apparatus in which a discharge port to the printed sheet is automatically separated from a discharge port to the sheet on which the print is unable for sorting, and thereby it is possible to reduce labor hours of a user.

It should be noted that in the above-mentioned explanation, the sheet in which both of the blank area on the first side and the blank area on the second side in the document are less than the print content area is discharged to the discharge port 2 as the sheet on which the print is unable, but the sheet in which neither of the first side and the second side in the document is the white sheet may be a sheet on which the print is unable.

### Other Embodiments

The present invention is not limited to the image forming apparatus having the conveying path form explained in each of the embodiments. That is, the present invention may be applied to any form of an image forming apparatus if the image forming apparatus is configured such that a document image having the backing sheet as a document is read, a blank area is determined based upon the read document image data, and an image corresponding to the print content can be formed on the blank area.

In addition, in the present embodiment, an explanation is made of the backing sheet in the on-printing process, but the present invention may be applied to a printing process in the other form. For example, the configuration of providing an image reading component near a feeding component for feeding a print sheet may be adopted. In addition, an embodiment in which the backing sheet is stored in the feeding component may be adopted.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer, for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application NO. 2012-254379, filed Nov. 20, 2012 which is hereby incorporated by reference herein in its entirety.

What is claimed is:

1. An image forming apparatus including a reading unit and a printing unit, comprising:
a conveying unit configured to include a conveying path enabling a print to be performed directly on a document read by the reading unit; and
a determining unit configured to determine whether or not the print is enabled on the document based upon an image of the document,
wherein in a case where it is determined that the print is enabled by the determining unit, the conveying unit conveys the document to the printing unit such that a print content is printed on the document.

2. An image forming apparatus according to claim 1, wherein
the determining unit extracts a blank area from the image of the document, and determines whether or not the print content is enabled to be printed on the extracted blank area.

3. An image forming apparatus according to claim 2, wherein
the determining unit determines that the print content is enabled to be printed in a case where the extracted blank area is larger than an area on which the print content is to be printed.

4. An image forming apparatus according to claim 1, wherein
for determining whether or not the print is enabled to be performed on the document in a one-side printing mode, the conveying unit, in a case where a first side of the document is not a white sheet, conveys the document to the reading unit in such a manner that a second side of the document is read.

5. An image forming apparatus according to claim 1, wherein
in a case where it is determined that the print is enabled to be performed on both sides of the document in a both-side printing mode, the determining unit determines that the print starts from a side of a white sheet among a first side and a second side.

6. An image forming apparatus according to claim 1, wherein
the determining unit determines that the print is performed on a larger black area among blank areas in the sheet upper and lower ends in the document from the sheet end side.

7. An image forming apparatus according to claim 1, wherein
the printing unit prints a mark together with the print content, wherein the mark shows an area on which the print is performed.

8. An image forming apparatus according to claim 1, wherein
the conveying unit conveys a sheet on which the print is performed and a sheet determined for the print to be unable respectively to different discharge ports.

9. An image forming apparatus comprising:
a determining unit configured to determine whether or not a print content is printable on a blank area of a document read by a reading unit; and
a printing unit configured to print, in a case where it is determined that the print content is printable by the determining unit, the print content on the blank area of the document read by the reading unit.

10. An image forming apparatus comprising:
a detecting unit configured to detect a blank area of a print sheet for printing a print content; and
a printing unit configured to print the print content on the blank area detected by the detecting unit.

11. An image forming method executed in an image forming apparatus including a reading unit, a printing unit, and a conveying unit configured to include a conveying path enabling a print to be performed directly on a document read by the reading unit, comprising:
determining whether or not the print is enabled on the document based upon an image of the document; and
conveying, in a case where it is determined that the print is enabled in the determining step, the document to the printing unit such that a print content is printed on the document.

12. A non-transitory computer readable storage medium storing a program for causing a computer to function as the image forming apparatus according to claim 1.
